(19) United States
(12) Patent Application Publication
(10) Pub. No.: US 2007/0168406 A1
(43) Pub. Date: Jul. 19, 2007

(54) Complementary linear feedback shift registers for generating advance timing masks

(76) Inventor: David R. Meyer, Lakewood, CO (US)

Correspondence Address: TENSORCOMM, INC., 1490 W. 121ST AVE., SUITE 202, WESTMINISTER, CO, 80234, US

(21) Appl. No.: 11/253,045

(22) Filed: Oct. 18, 2005

(51) Int. Cl. G06F 7/58

(52) U.S. Cl. 708/252

(57) ABSTRACT

A mask required to generate a time-offset version of a PN code may be generated by constructing a Galois linear feedback shift register (LFSR) that is complementary to a Fibonacci LFSR that generates the PN code, clocking the Galois LFSR a number of times equal to the time offset, and reading the state of the Galois LFSR, which is the desired mask.

### BACKGROUND

1. Field of the Invention

The present invention relates generally to linear feedback shift registers used in spread spectrum systems to scramble data for transmission, and specifically to generating advance timing masks for pseudorandom noise sequences.

2. Discussion of the Related Art

Code division multiple access (CDMA) cellular communication systems employ unique pseudorandom noise (PN) code sequences that identify base stations in forward-link communications and identify cellular handsets in reverse-link communications. The PN sequence assigned to a transmitter (e.g., a base station or cellular handset) is derived from a time offset of a reference sequence.

A Linear Feedback Shift Register (LFSR) is typically used in CDMA and WCDMA base stations to synthesize PN codes for scrambling data transmissions. An LFSR implementation is typically implemented in hardware and clocked at the chipping rate. The output of the LFSR is XORed with the transmit data. Each base station uses a different LFSR offset to scramble the data, and thus, differentiates its transmissions from those of adjacent base stations. LFSR sequences having different offsets are typically generated using an advance-timing mask from a common base sequence. The mask determines which registers of the LFSR are combined. WCMDA employs truncated LFSR sequences, wherein each base station is characterized by a different offset from the base sequence. In the handset, this requires mask storage and/or generation for each base station supported. For example, if all Primary Scrambling Codes (PSC) are supported, then 512 masks are needed.

### SUMMARY OF THE INVENTION

In view of the foregoing background, embodiments of the present invention may provide for generating LFSR masks in real time. Such embodiments may be employed in any receiver configured to support one or more CDMA standards, such as (1) the “TIA/EIA-95-B Mobile Station-Base Station Compatibility Standard for Dual-Mode Wideband Spread Spectrum Cellular System” (the IS-95 standard), (2) the “TIA/EIA-98-C Recommended Minimum Standard for Dual-Mode Wideband Spread Spectrum Cellular Mobile Station” (the IS-98 standard), (3) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the WCDMA standard), (4) the standard offered by a consortium named “3rd Generation Partnership Project 2” (3GPP2) and embodied in a set of documents including “TR-45.5 Physical Layer Standard for cdma2000 Spread Spectrum Systems,” the “C.S0005-A Upper Layer (Layer 3) Signaling Standard for cdma2000 Spread Spectrum Systems,” and the “C.S0024 CDMA2000 High Rate Packet Data Air Interface Specification” (the CDMA2000 standard), and (5) other CDMA standards.

Embodiments of the invention include methods and programs for determining a PN generator mask for a particular shift of a PN sequence. One embodiment of the invention may provide for using a Galois LFSR to generate a mask for a Fibonacci LFSR. In another embodiment, a Fibonacci LFSR may be used to generate a mask for a Galois LFSR. Embodiments described herein may be employed in subscriber-side devices (e.g., cellular handsets, wireless modems, and consumer premises equipment) and/or server-side devices (e.g., cellular base stations, wireless access points, wireless routers, wireless relays, and repeaters). Particular circuit embodiments may be integrated into a searcher/tracker circuit of a CDMA receiver. Chipsets for subscriber-side and/or server-side devices may be configured to perform at least some of the signal processing functionality of the embodiments described herein.

Various functional elements, separately or in combination, depicted in the figures may take the form of a microprocessor, digital signal processor, application specific integrated circuit, field programmable gate array, or other logic circuitry programmed or otherwise configured to operate as described herein. Accordingly, embodiments may take the form of programmable features executed by a common processor or discrete hardware unit.

These and other embodiments of the invention are described with respect to the figures and the following description of the preferred embodiments.

### BRIEF DESCRIPTION OF THE DRAWINGS

Embodiments according to the present invention are understood with reference to the schematic block diagrams of FIG. 1, 2A, and 2B. Various functional units depicted in the figures may take the form of a microprocessor, digital signal processor, application specific integrated circuit, field programmable gate array, or other logic circuitry programmed or otherwise configured to operate as described herein. Accordingly, embodiments shown herein may take the form of programmable features executed by a common processor or a discrete hardware unit.

FIG. 1 is a block diagram illustrating an LFSR employing a mask.

FIG. 2A is a block diagram of a shift register for a Galois LFSR that implements a WCDMA x-sequence polynomial.

FIG. 2B shows a block diagram corresponding to a Fibonacci implementation of the WCDMA x-sequence polynomial.

FIG. 3 is a block diagram illustrating an LFSR employing a mask in accordance with an embodiment of the invention.

### DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

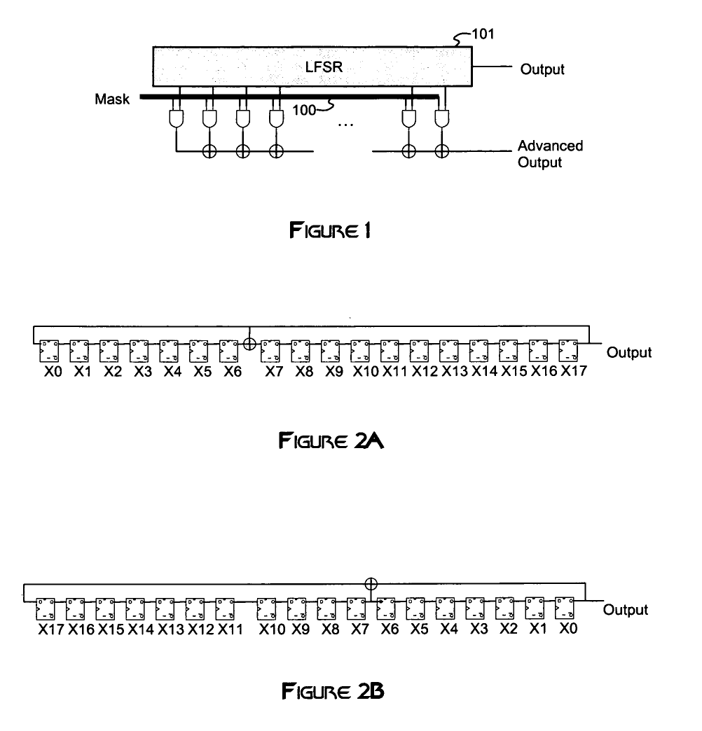

Due to the cyclical nature of sequences synthesized by the LFSRs, a mask 100 can be used to generate an advanced replica of the LFSR 101 output, such as shown in FIG. 1. FIG. 2A shows a Galois implementation that is based on the WCDMA x-sequence polynomial p(x)=x¹⁸+x⁷+1 specified in section 5.2.2 of the 3GPP TS 25.213 specification, which is hereby incorporated by reference. The Galois implementation can be represented by a state equation
xₙ₊₁=A_{G}xₙ,
where xₙ is an M×1 state vector (e.g., an initial loading x₀, x₁, . . . , x₁₇) of an M-bit LFSR and A_{G} is an M×M state transition matrix. The state transition matrix A_{G} is
A_{G}=Z+(e₇e₁₇^{T}),
where Z represents a cyclic delay of the identity matrix and eᵢ is a standard basis vector of zeroes except for a one at the i^{th} position.

FIG. 2B shows a Fibonacci implementation of the same WCDMA x-sequence polynomial. The Fibonacci implementation can be represented by a state equation
xₙ₊₁=A_{F}xₙ,
where the state transition matrix A_{F} is
A_{F}=Z^{T}+(e₁₇e₇^{T})=A_{G}^{T}.

Masks are typically generated via matrix multiplication, which may be represented as an iterative application of the previously shown LSFR transfer equations. For example, an advance of k cycles for the Fibonacci implementation may be expressed by
xₙ₊ₖ=A_{F}^{k}xₙ
Since the output in the Fibonacci implementation is the x₀ element of the state vector x, the mask used to generate the advanced output is the zeroth row of the A_{F}^{k} matrix. That is, the mask mₖ^{T} is the row vector
m^{k}^{T}=eₒ^{T}A_{F}^{k},
where eₒ^{T}=[1 0 . . . 0 0]. This yields the modified state equation
x_{(0,n+k)}=mₖ^{T}xₙ,
where x_{(0,n+k)} is the first element in the xₙ₊ₖ vector.

Galois and Fibonacci LFSR implementations are complementary because their state transition matrices are transposes of each other. Thus, an LFSR mask can be generated by seeding a complementary LFSR with an appropriate state value and clocking the register k times, which is the timing advance required.

By considering that A_{F}=A_{G}^{T}, the mask mₖ^{T} (which is row 0 Of A_{F}^{k})is the transpose of column 0 of A_{G}^{k}:
mₖ^{T}=e₀^{T}A_{F}^{k}=e₀^{T}(A_{G}^{T})^{k}=(A_{G}^{k}e₀)^{T}.
Thus, the mask mₖ^{T} can be synthesized in hardware by loading a Galois LFSR with the e₀ vector and clocking it k times. The resulting state is the mask mₖ.

This process can be used to generate masks specified in the WCMDA specification that advances the X and Y LFSRs to generate both the in-phase and quadrature terms of a Gold Code. For example, the mask m₁₃₁₀₇₂ may be expressed by

$$\begin{matrix}{m}_{131072}^{T} = {e}_{0}^{T} {A}_{F}^{131072} \\ = {( {A}_{G}^{131072} {e}_{0} )}^{T} \\ = [ \begin{matrix}0 & 0 & 0 & 0 & 1 & 0 & 1 & 0 & 0 & 0 & 0 & 0 & 0 & 0 & 1 & 0 & 0 ] .\end{matrix}\end{matrix}$$

The mask m₁₃₁₀₇₂ is static and can be generated via software. In WCMDA, truncated LFSR sequences are implemented whereby each base station employs a different offset from the base sequence. In the handset, this requires mask storage and/or generation for each base station supported. For example, support of all Primary Scrambling Codes (PSC) requires 512 masks. Support for both PSC and Secondary Scrambling Codes (SSC) requires 8192 masks. The storage requirements for pre-computed masks can be significant. Therefore, an advantageous alternative to storage would be to provide for a simple circuit to compute the masks in real time.

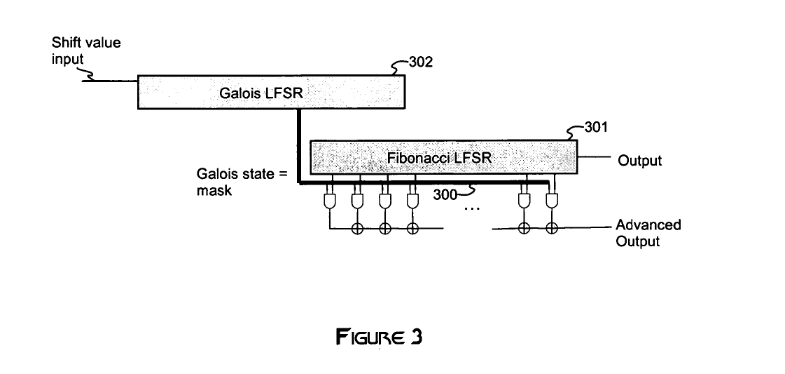

FIG. 3 is a block diagram of a circuit in accordance with an exemplary embodiment of the invention. A mask 300 for a first LFSR 301 (e.g., a Fibonacci LFSR) is generated by a second LFSR 302 (e.g., a Galois LFSR) that is complementary to the first LFSR 301. The second LSFR 302 is provided with an enable signal (not shown) and a shift-value k input. The shift value k provides the number of cycles at which to advance the second LFSR 302 in order to produce the appropriate mask 300 for the first LFSR 301.

Those skilled in the art should recognize that method and apparatus embodiments described herein may be implemented in a variety of ways, including implementations in hardware, software, firmware, or various combinations thereof. Examples of such hardware may include Application Specific Integrated Circuits (ASICs), Field Programmable Gate Arrays (FPGAs), general-purpose processors, Digital Signal Processors (DSPs), and/or other circuitry. Software and/or firmware implementations of the invention may be implemented via any combination of programming languages, including Java, C, C++, Matlab™, Verilog, VHDL, and/or processor specific machine and assembly languages.

Computer programs (i.e., software and/or firmware) implementing the method of this invention may be distributed to users on a distribution medium such as a SIM card, a USB memory interface, or other computer-readable memory adapted for interfacing with a consumer wireless terminal. Similarly, computer programs may be distributed to users via wired or wireless network interfaces. From there, they will often be copied to a hard disk or a similar intermediate storage medium. When the programs are to be run, they may be loaded either from their distribution medium or their intermediate storage medium into the execution memory of a wireless terminal, configuring an onboard digital computer system (e.g. a microprocessor) to act in accordance with the method of this invention. All these operations are well known to those skilled in the art of computer systems.

The method and system embodiments described herein merely illustrate particular embodiments of the invention. It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as applying without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for generating a linear feedback shift register (LFSR) mask for a first LFSR, comprising:
providing for a second LFSR that is complementary to the first LFSR,
providing for clocking the second LFSR a number of times equal to a desired timing advance, and
providing for using a state of the second LFSR as the LFSR mask for the first LFSR.

2. The method recited in claim 1, wherein the first LFSR is a Galois LFSR and the second LFSR is a Fibonacci LFSR.

3. The method recited in claim 1, wherein the first LFSR is a Fibonacci LFSR and the second LFSR is a Galois LFSR.

4. The method recited in claim 1, wherein the mask is configured to generate in-phase and quadrature terms of a Gold code.

5. A subscriber-side device configured to perform the method recited in claim 1.

6. A server-side device configured to perform the method recited in claim 1.

7. A searcher/tracker circuit configured to perform the method recited in claim 1.

8. A circuit configured to compute at least one mask for a first LFSR, comprising:
a second LFSR that is complementary to the first LFSR,
a shift-value input to the second LFSR, the shift-value input configured for clocking the second LFSR a number of times equal to a desired timing advance, and
a state input to the first LFSR configured for receiving a state of the second LFSR as the at least one mask for the first LFSR.

9. The circuit recited in claim 8, wherein the first LFSR is a Galois LFSR and the second LFSR is a Fibonacci LFSR.

10. The circuit recited in claim 8, wherein the first LFSR is a Fibonacci LFSR and the second LFSR is a Galois LFSR.

11. The circuit recited in claim 8, wherein the mask is configured to generate in-phase and quadrature terms of a Gold code.

12. The circuit recited in claim 8 configured to operate in a subscriber-side device.

13. The circuit recited in claim 8 configured to operate in a server-side device.

14. The circuit recited in claim 8 configured to operate in a searcher/tracker circuit.

15. A computer-readable memory configured to compute at least one mask for a first LFSR, said computer-readable memory configured for implementing the steps of:
providing for a second LFSR that is complementary to the first LFSR,
providing for clocking the second LFSR a number of times equal to a desired timing advance, and
providing for receiving a state of the second LFSR as the at least one mask for the first LFSR.

16. The computer-readable memory recited in claim 15, wherein the first LFSR is a Galois LFSR and the second LFSR is a Fibonacci LFSR.

17. The computer-readable memory recited in claim 15, wherein the first LFSR is a Fibonacci LFSR and the second LFSR is a Galois LFSR.

18. The computer-readable memory recited in claim 15, wherein the mask is configured to generate in-phase and quadrature terms of a Gold code.

19. The computer-readable memory recited in claim 15 configured to reside on a subscriber-side device.

20. The computer-readable memory recited in claim 15 configured to reside on a server- side device.

21. The computer-readable memory recited in claim 15 configured to reside in a searcher/tracker circuit.
